(19) United States
(12) Patent Application Publication
(10) Pub. No.: US 2015/0379884 A1
(43) Pub. Date: Dec. 31, 2015

(54) AIRCRAFT SIMULATOR

(71) Applicant: ONE-G, LLC, Seattle, WA (US)

(72) Inventor: Xylon SALTZMAN, Seattle, WA (US)

(21) Appl. No.: 14/766,012

(22) PCT Filed: Feb. 4, 2014
(86) PCT No.: PCT/US2014/014640

§ 371 Date: Aug. 5, 2015

Related U.S. Application Data
(60) Provisional application No. 61/761,044, filed on Feb. 5, 2013.

(51) Int. Cl. G09B 9/08

(52) U.S. Cl. CPC G09B 9/08

(57) ABSTRACT

A modular aircraft simulator is constructed from an aluminum exoskeleton structure supporting a panel skin formed of flexible, resilient panels releasably affixed to an interior of the exoskeleton. The exoskeleton and panel skin together create an enclosure that is representative of an aircraft cockpit. The aircraft simulator includes a system of integrated hardware and software that permit an instructor (e.g., operator of the instructor console) to provide instruction to the student (e.g., operator of the aircraft simulator) from a remote location via data transfer over a network such as the internet. A remote interface system includes a multi-step identity verification process to allow the instructor to verify and confirm the identity of the student prior to commencing a training session and throughout the training session.

### FIELD

This specification generally relates to aircraft simulation, for example, to assembly methods for, and use of, an aircraft simulator.

### BACKGROUND

Generally speaking, an aircraft simulator—also sometimes referred to as a flight simulator—is an apparatus that artificially re-creates aircraft flight and various aspects of an aircraft's environment. Typically, an aircraft simulator will take into account the mathematical equations that govern how aircraft fly, how they react to applications of their controls and other aircraft systems, and how they react to external environmental factors such as air density, turbulence, cloud, precipitation, and the like. Flight simulation is used for a variety of reasons, including flight training (mainly of pilots), the design and development of the aircraft itself, and research into aircraft characteristics and control handling qualities

Depending on their purpose, aircraft simulators employ various types of hardware, modeling detail and realism. They can range from PC laptop-based models of aircraft systems to simple replica cockpits for familiarization purposes to more complex cockpit simulations with some working controls and systems to highly detailed cockpit replications with all controls and aircraft systems and wide-field outside-world visual systems, all mounted on six degrees-of-freedom (DOF) motion platforms which move in response to pilot control movements and external aerodynamic factors.

### SUMMARY

In general, this document describes, among other things, a system and process for building an aircraft simulator that allows for rapid assembly/disassembly of parts through the use of a system of modular components that are fastened together with bolt and captured T-nut hardware to create the aircraft simulator enclosure and its subsystems. Among other potential advantages, the disclosed construction and method of assembly tends to greatly reduce the amount of time required for the assembly of the aircraft simulator on-site (i.e., location of intended use), tends to greatly reduce the amount of physical space required for the transport/shipping of the aircraft simulator (e.g., by allowing components to be disassembled to a state small enough to flat pack) and further allows for the possibility of the use of the aircraft simulator in locations where the use of prior art aircraft simulators may not be feasible due to physical space limitations and/or access limitations.

The aircraft simulator as described herein also may enable the Flight Instructor to communicate with the Student Pilot and to manipulate parameters of the aircraft simulator from a remotely located instructor interface, with fidelity that is equal to that which would exist if the Flight Instructor and Student Pilot were co-located. This is accomplished through a system comprised of digital video cameras, audio microphones, audio speakers and data transfer protocols, all of which is transported via a packet-switched communications network (e.g., LAN, WAN, internet).

The aircraft simulator as described herein also may utilize an Identity Verification System (IVS) that permits the Flight Instructor to accurately verify the Student Pilot's identity prior to commencing training and at any time during the training through the use of a combination of digital camera image and a uniquely coded Universal Serial Bus (USB) key (or, equivalently, dongle), even though the Flight Instructor and the Student may be remote from each other (i.e., not co-located).

Details of one or more implementations of the subject matter described in this specification are set forth in the accompanying drawings and the description below. Other features, aspects, and potential advantages of the subject matter will become apparent from the description, the drawings, and the claims.

### BRIEF DESCRIPTION OF THE DRAWINGS

FIG. 1A is an exterior front view of an aircraft simulator.

FIG. 1B is an interior view of an aircraft simulator cockpit.

FIG. 2A is a side view of an aircraft simulator.

FIG. 2B is a rear view of an aircraft simulator.

FIG. 3 illustrates detail of a connection between a flexible resilient panel and a support member.

FIG. 4A is a diagram of a remote interface training system.

FIG. 4B is a diagram of an identity verification system.

FIG. 5 is a block diagram of computing devices that may be used to implement certain systems and methods described in this document.

Like reference numbers and designations in the various drawings indicate like elements.

### DETAILED DESCRIPTION

Generally speaking, aircraft simulators used in pilot training can range from simple desktop mounted systems (typically used for practicing the basic skills required for safely piloting and/or navigating aircraft to advanced systems) to systems having three-axis motion (typically used for training pilots of large, complex aircraft). Some aircraft simulators are built using various plastics, metals and composites that are replicas or near replicas of the components found in the aircraft being represented by the aircraft simulator. Many of these aircraft simulators utilize a dedicated instructor console, allowing a Flight Instructor to manipulate certain parameters of the aircraft simulator such that the Student Pilot may notice and respond to the changes in the state of certain systems of the aircraft (including system failures and/or irregularities), changes in the environment surrounding the simulated aircraft (weather, time of day, season, etc.) and may communicate verbally with the Flight Instructor.

As with any arrangement between an instructor and a student, ideally there must be an accurate method of identity verification between the Flight Instructor and Student Pilot. When they are co-located, a Flight Instructor typically verifies a Student Pilot's identity prior to commencing instruction through visual recognition of the Student and/or inspection of the Student's identity documents.

A modular aircraft simulator with a remote training interface system and identity verification system is described in the following text and illustrated in the accompanying figures. The modular aircraft simulator is constructed utilizing a modular system comprised of an aluminum exoskeleton structure supporting a panel skin, together which creates an enclosure that is representative of an aircraft cockpit. Among other potential advantages, this modular method of construction allows for rapid assembly, disassembly and modification of the overall shape and size of the aircraft simulator. The aircraft simulator includes a system of integrated hardware and software that permit an instructor (e.g., operator of the instructor console) to provide instruction to the student (e.g., operator of the aircraft simulator) from a remote location via data transfer over a network such as the internet. This remote interface system includes a multi-step identity verification process to allow the instructor to verify and confirm the identity of the student prior to commencing a training session and throughout the training session.

The following provides details of an aircraft simulator having one or more of the following properties:
(1) A modular construction method permitting rapid assembly, disassembly and/or dimensional modification of the design, which greatly reduces manufacturing, assembly and transport costs.
(2) A Remote Interface Training System (RITS) permitting reliable, secure and clear communication between a Flight Instructor and Student Pilot who are not co-located.
(3) An Identity Verification System (IVS) that accurately maintains positive identity verification of the Student throughout the simulation even though the Flight Instructor and Student may be remote from each other (i.e., not co-located).

### Modular Construction

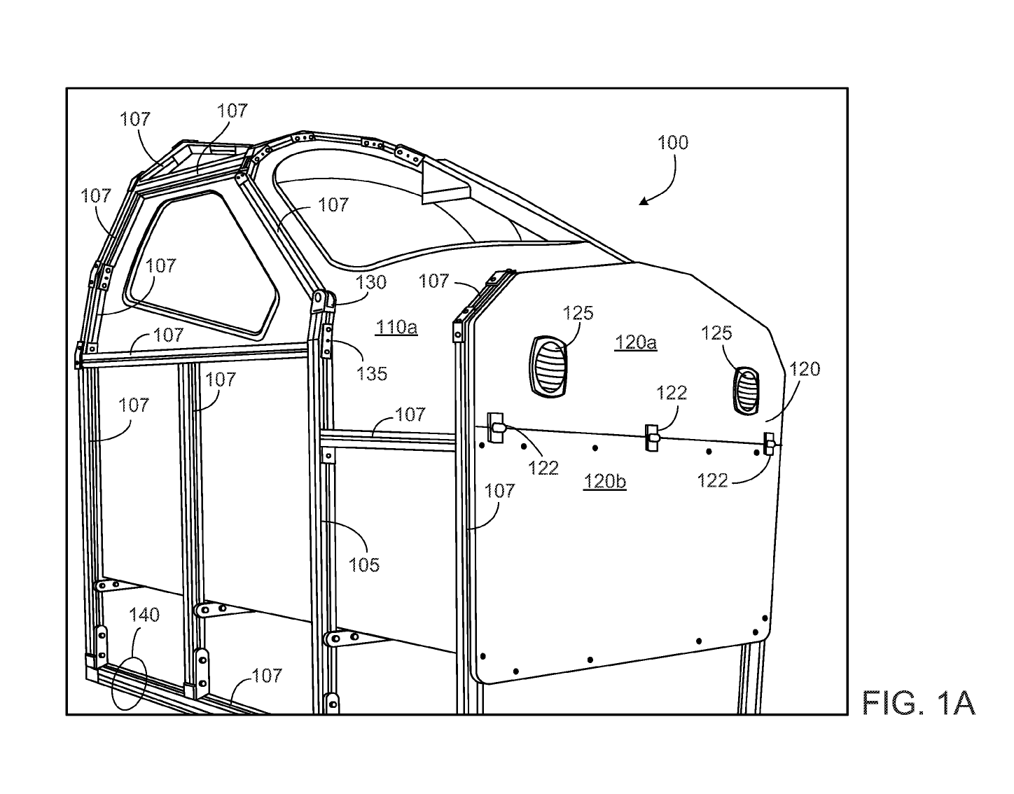

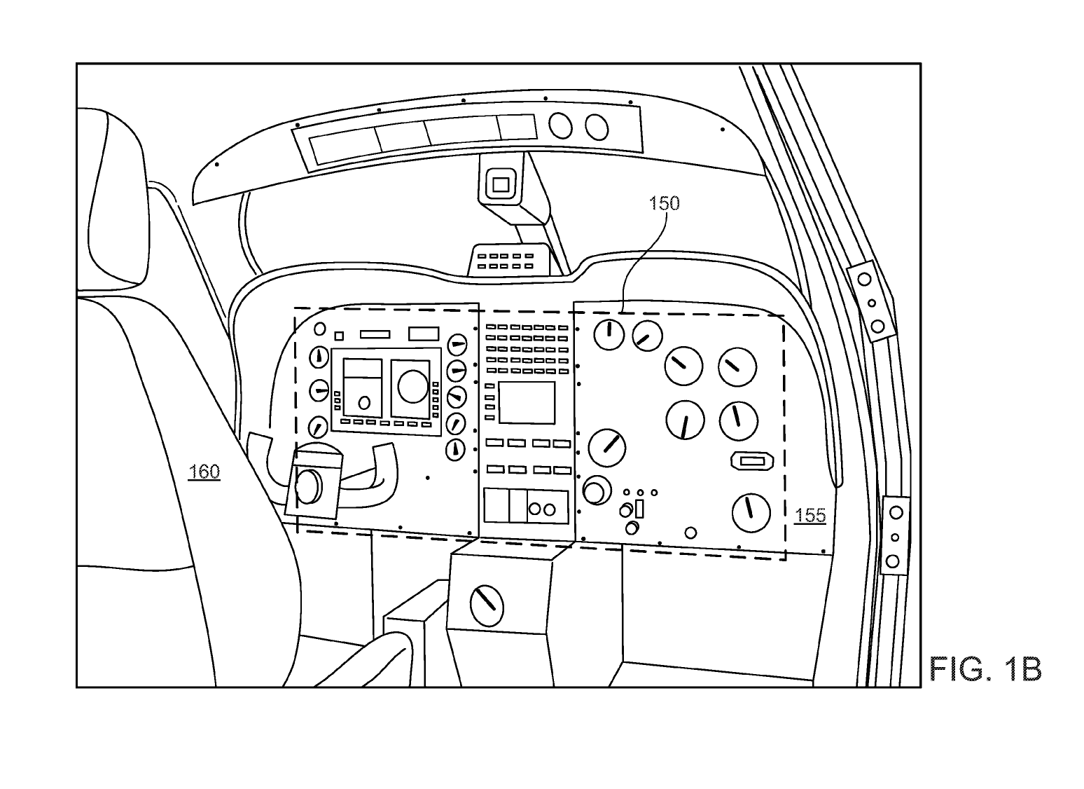

FIG. 1A is an exterior view of an aircraft simulator 100 that may be constructed using the modular techniques described herein. As illustrated, the aircraft simulator 100 includes a load-bearing (e.g., capable of supporting an adult human and various computers, electronics and other furnishings and equipment) exoskeleton 105 formed from interconnected rigid, support members 107 (e.g., straight extruded aluminum channels), which are removably connected by aluminum plates 135 to provide rigidity and connection between the support members 107. In addition, one or more pivot connectors 130 can be used to create adjustable angles between adjacent support members 107.

Disposed inside the exoskeleton 105 are one or more (in this example, three) flexible, resilient planar panels 110a, 110b, 110c (not visible) made, for example, of approximately ¼″ thick PVC plastic. The panels 110, which can have openings 115 that simulate windows on the aircraft, are releasably affixed to the inside of the exoskeleton 105, e.g., using bolts and T-lock nuts such that the bolt extends through a pre-formed hole in the panel 110 and the T-lock nut fits in an accommodating channel formed in the support member 107 to which the panel 110 is affixed. In their unfixed state, the panels 110 are planar and thus lie flat to facilitate easy and efficient handling, packing, storage and/or transport. When affixed to the inside of the exoskeleton 105, however, the panels 110 flex to become flush against the inside of the exoskeleton 105 and, as a result, form a non-planar contour that approximates a hull of an aircraft. In addition, when affixed, the panels 110 impart shear strength to the aircraft simulator structure.

The aircraft simulator 100 also includes a front panel 120, formed of top panel 120a which is connected by hinges 122 to bottom panel 120b. Top panel 120a can be opened on the hinges 122 to provide access to flight simulator electronics or other equipment disposed inside the aircraft simulator hull. In addition, the top panel 120a includes vents 125 to provide cooling for the aircraft simulator equipment in the hull. Wheels 140, potentially with casters, are provided to facilitate easy movement of the aircraft simulator 100 to desired locations.

Different aircraft, which tend to have different external and/or internal appearances, can be simulated by appropriately changing the configurations (e.g., relative positions, lengths, angles) of the interconnected support members 107, thereby forming an exoskeleton 105 of a desired shape, which in turn will cause the panels 110, when affixed, to form a contour that approximates the shape of the hull of the aircraft being simulated.

FIG. 1B is an interior view of the aircraft simulator's cockpit. As illustrated, various input and output mechanisms (e.g., displays, dials, gauges, switches, etc. such as would be found in the aircraft being simulated) disposed in a dashboard 155 collectively provide flight simulation functionality. A seat 160 is positioned inside the cockpit at an appropriate position to enable a seated student pilot to access the various controls. As can be seen in FIG. 1B, the exoskeleton 105 is not visible from inside the cockpit thereby adding to the reality of the aircraft simulation environment.

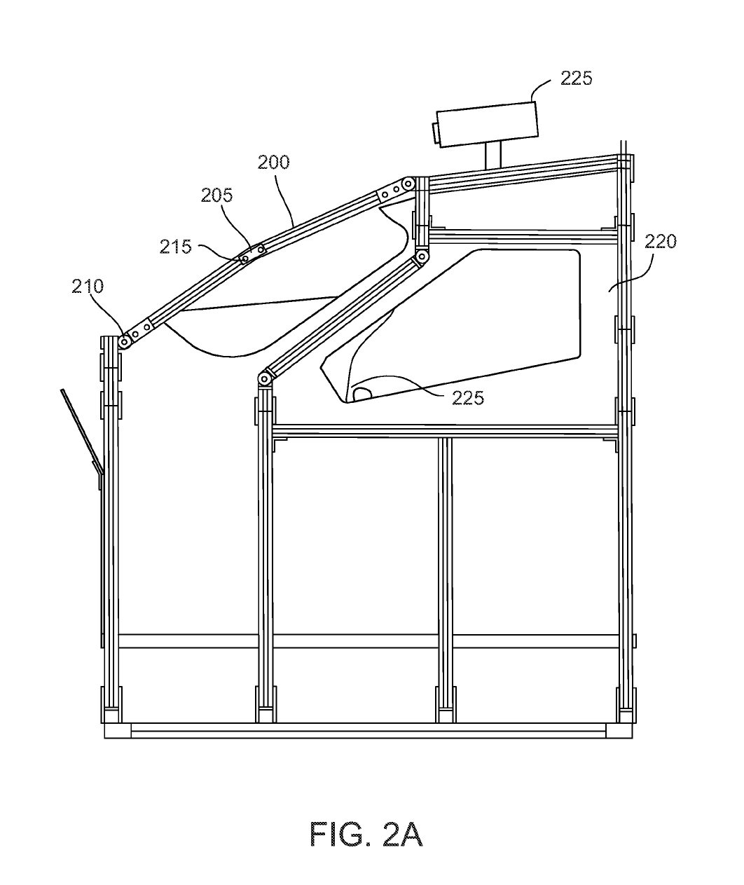

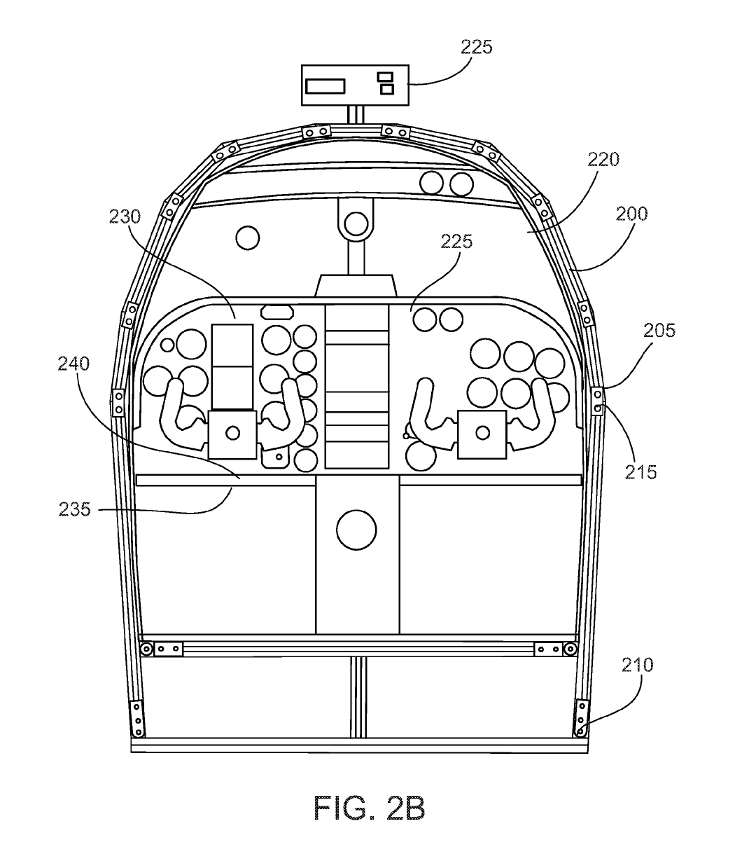

FIGS. 2A and 2B illustrate details for constructing a modular aircraft simulator. Reference numerals in these figures correspond to the following elements:

200—Extruded aluminum channel used as modular structural support member

205—Aluminum plates used to provide rigidity and connection between supports

210—Aluminum pivot connectors used to create adjustable angles between supports

215—Bolts and T-lock nuts used to fasten plates or panels to supports

220—PVC plastic panel used as modular wall and/or ceiling enclosure

225—Attached accessories

230—Digital camera

235—Audio speaker

240—Microphone

245—Display

250—Aircraft simulator

255—Instructor console

260—Client software

265—Host software

270—USB port used for HASP USB identity verification key

In terms of physical construction, the physical body of the aircraft simulator can be divided into three primary categories: Support Structure 200, 205, 210, 215 (i.e., exoskeleton framing), Supported Enclosure 215, 220 (i.e., the flexible, resilient panels that collectively form the aircraft simulator's hull) and Attached Accessories 225 (various hardware, electronic components, etc). FIGS. 2A and 2B show side and rear views, respectively, of the aircraft simulator in a fully assembled state. From these views, both the Support Structure 200, 205, 210, 215 and the Supported Enclosure 215, 220 are visible, together creating a three dimensional spatial element that is representative of an actual aircraft cockpit environment. From the interior position of this spatial element, the Support Structure 200, 205, 210, 215 is largely hidden (obscured by the Supported Enclosure paneling 220), just as would be typical of an actual aircraft interior. From the exterior, however, the Support Structure 200, 205, 210, 215 remains visible and accessible, allowing for easy access to the fasteners and joining plates used. Each of these three primary categories is further described as follows:

Support Structure: The Support Structure 200, 205, 210, 215 is formed from commercially available extruded aluminum tubing 200 with full length T-slot channels, which allow for the mechanical attachment of structural fastening plates 205, structural pivots 210, movable castors and floor leveling supports through the use of a combination of bolts and T-nuts 215. This Support Structure 200, 205, 210, 215 can be disassembled into small individual parts as required for packing and shipping. The Support Structure 200, 205, 210, 215, once assembled is lightweight and rigid and forms the structural framework used to support the Supported Enclosure 215, 220, Attached Accessories 225 and occupant(s) of the aircraft simulator.

Supported Enclosure: The Supported Enclosure 215, 220 is attached to the Support Structure 200, 205, 210, 215 through the use of a combination of bolts and T-nuts 215. This enclosure 220 is formed of PVC panels and/or wood panels and/or metal panels, that are used to create a visible skin and floor that in-fills the open framework of the Support Structure 200, 205, 210, 215 and provides greater rigidity against shear forces that may be applied to the Support Structure 200, 205, 210, 215 during occupancy. Because the Supported Enclosure 215, 220 does not need to directly support the dead load of the materials and live loads applied by the occupant(s), the materials used may generally be flexible and lightweight allowing for easy transport through flat packing. This Supported Enclosure 215, 220 is also what creates the look (from the interior position) of an actual aircraft cockpit since the surfaces may be cut and shaped to represent the opaque surfaces and transparent/translucent openings that are found in an actual aircraft cockpit.

Attached Accessories: In addition to allowing for the attachment of the Supported Enclosure 215, 220, the extruded aluminum tubing 200 of the Support Structure 200, 205, 210, 215 allows for the attachment of the Attached Accessories 225. The Attached Accessories 225 include the remaining components needed to complete the look of the aircraft cockpit and the function of the electrical and mechanical elements of the aircraft simulator. These include but are not limited to hinges, instrument panels, grip-able handles, electronic components, switch panels, cameras, display projectors, lighting, wiring harnesses, computers, seating and the other mechanical assemblies used to emulate the functions of the flight controls found within the actual aircraft being represented (such as rudder pedals, control yokes, engine controls, etc.). These Attached Accessories 225 are fastened to the Support Structure 200, 205, 210, 215 in the same manner as the Supported Enclosure 215, 220, through the use of bolts and T-nuts 215 as well as with plastic T-channel plugs combined with #12 sheet metal screws (used for lightweight components such as wire harness attachments).

Layout process: The first step in the layout process is to approximate, with reasonable accuracy, the dimensional values for the aircraft simulator, based on actual physical measurements of, or scaled photographic images of, or a combination of physical measurements and scaled photographic images of the actual aircraft model being simulated by the aircraft simulator 250. These dimensional values are used to create a set of scaled layout drawings of the aircraft simulator, such as the examples referenced in FIGS. 2A and 2B. These scaled layout drawings allow for the determination of the relative location, exact lengths of the extruded aluminum channels 205, exact angles of cuts made at each end, and exact number of sections of extruded aluminum channel 205 required to form the desired shape of the Support Structure 200, 205, 210, 215. In addition to determining the overall size and shape of the aircraft model being simulated by the aircraft simulator 250, the location of window openings, and Attached Accessories 225 are determined during this layout process. The information about the location and shape of these window openings is later used in the fabrication process of the Supported Enclosure panels 220. In each separate embodiment of the aircraft simulator 250, the dimensions used and the shapes and relative location of shapes of the window openings may vary, such that this layout process, overall, is a step that is required only when a new aircraft model is to be simulated by the aircraft simulator 250. This is relevant because it should be noted that the specific number of extruded aluminum channels 205, their relative location, their exact length and angle of cut made at each end will vary from one embodiment to the next. In other words, once the scaled layout drawings for a particular aircraft model have been created, using the above layout process, these scaled layout drawings may be referred to during the fabrication step, and this layout process need not be duplicated for the fabrication of the aircraft simulator 250 of the same embodiment.

Material estimation process: The layout drawings created in the layout process, described above, are used to estimate total aluminum channel material length required, number of aluminum plates 205, number of aluminum pivot connectors 210, number of bolts and T-lock nuts 215, amount and type of panel material 220, and number and type of attached accessories 225 required to fabricate the embodiment of the aircraft simulator described in the layout drawings. This estimate process results in a parts and materials bill that is used to purchase materials and is further used during the fabrication process to verify that the correct part type and quantity are used in the fabrication of the aircraft simulator 250. Once this materials bill has been created it may be used for the fabrication of the aircraft simulator 250 of the same embodiment.

Fabrication process: The layout drawings and the parts and materials bill are referred to and cross referenced during the fabrication process to inform the fabricator of what material to select, where it is to be cut and/or drilled and/or tapped and/or attached, etc. to fabricate the aircraft simulator 250. The fabrication process begins with the Support Structure 200, 205, 210, 215 and; more specifically begins with the fabrication and assembly of the aluminum channels 200, aluminum plates 210 and bolts and T-lock nuts 215 on the lowermost portion (i.e. base) of the Support Structure 200, 205, 210, 215. Aluminum channels 200 are cut to the correct length and the ends cut at the correct angle, as determined by reference to the layout drawings, using a carbide tipped blade attached to a rotary chop saw that is capable of cutting the aluminum channel 200 at any appropriate angle between 0 and 50 degrees.

The individual aluminum channels 200 are then connected together using a combination of aluminum plates 205 and bolts and T-lock nuts 215, the type, quantity and location of which are determined by cross referencing the layout drawings with the materials bill list. The physical connection is made by passing a bolt 215 through an aluminum plate 205 followed by hand attaching a T-lock nut to the bolt 215 and then sliding the T-lock nut 215 of this this now coupled assembly into the T-channel groove of the aluminum channel 200 and tightening using a hex driver. As the bolt is tightened, the T-lock nut 215 is held within the T-channel groove of the aluminum channel 200 by the friction created between the T-lock nut 215 and the aluminum channel 200, which serves to hold the aluminum plate 205 in the desired position.

The exact number of bolts and T-lock nuts used in each connection depends on the aluminum plate 205 used at that location. At certain locations, as determined by reference to the layout drawings, the fabricator drills access holes in the aluminum channel 200. These access holes may be used to connect aluminum channels that coexist in the same plane and meet at right angles, or near right angles through the use of a bolt that passes through one aluminum channel 200 and threads into the cut end of another aluminum channel 200, 105, 107. In these instances, the fabricator first taps the cut end of the aluminum channel 200 prior to assembly, such that the bolt used can thread into it and be tightened via access to the bolt head with a hex driver through the access hole. At other locations, a pivot connector 210 may be used to allow for a union between two aluminum channels 200 where an adjustable angle is desired. The fabricator continues this process, working from the base of the Support Structure 200, 205, 210, 215 upward until each aluminum channel 200 required to form the shape and size depicted in the layout drawing has been connected, the completion of which results in the formation of the Support Structure 200, 205, 210, 215.

The next step in the fabrication process is to cut the enclosure panel 220 and attach it to the Support Structure 200, 205, 210, 215 using bolts and T-lock nuts 215. The locations of the cuts made to the enclosure panel 220 are determined by referencing the layout drawings. The cuts can be made by computer numerically controlled (CNC) router and/or hand router and/or jig saw using standard bits/blades that appropriate for the material being cut. Panel thickness and material compositions can vary, depending on the application of use. Floor panel will typically be made of plywood of approximately ¾″ thickness, which will inherently resist bending and form a flat and rigid surface; while other enclosure panels 220 will typically be made of PVC of approximately ¼″ thickness, which will allow for smooth bending where desired, and will return to a flat plane when removed from the Support Structure 200, 205, 210, 215 allowing for packing and shipping. The points at which the enclosure panels 220 attach to the Support Structure 200, 205, 210, 215 depend upon the radius desired, which is determined by reference to the layout drawings, such that the enclosure panels 220, when bent by hand, will naturally contact the Support Structure 200, 205, 210, 215 informing the fabricator that a hole should be drilled at that location to accept a bolt and T-lock nut 215. Once these holes have been drilled where required, the enclosure panel 220 may be used as a template for the fabrication of the aircraft simulator 250 of the same embodiment.

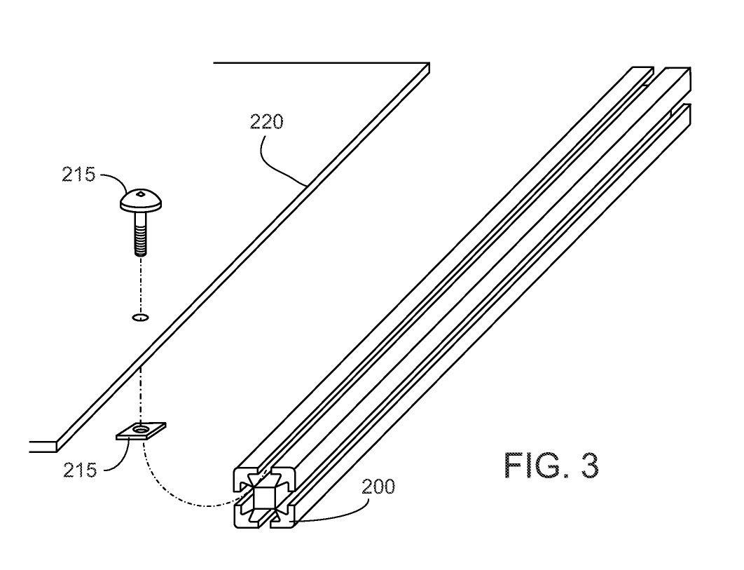

FIG. 3 shows detail of how the fastening bolts and T-nuts 215 attach to the T-slot channels 200. Because the T-slot channel 200 is continuous along the entire length of the aluminum material, the Supported Enclosure elements 215, 220 and Attached Accessories 225 may be connected to the Support Structure 200, 205, 210, 215 at any position desired, which allows for exceptional customizability in the overall dimension and shape of the aircraft simulator. In addition, by using a visible exoskeleton Support Structure 200, 205, 210, 215 (instead of a hidden support system) the mechanical hardware connections remain easily accessible making assembly/disassembly both simple and rapid.

Due to the modular nature used in the construction of the aircraft simulator, the specific aluminum structural support members 200, their individual dimensions, quantities, relative positions, mounting plate shapes/sizes 205, enclosure paneling sizes/shapes 220 and number of fasteners 215 used may vary from the depicted examples shown in the figure drawings and diagrams. Moreover, the modular nature used in constructing the aircraft simulator provides several potential advantages. For example, an aircraft simulator as described here be rapidly assembled and disassembled. Additionally, the aircraft simulator may be easily modified in overall dimension and shape, which allows for the manufacturing of various versions (models) of aircraft simulators 250 without the need to implement a new method of assembly for each subsequent version.

### Remote Interface Training System

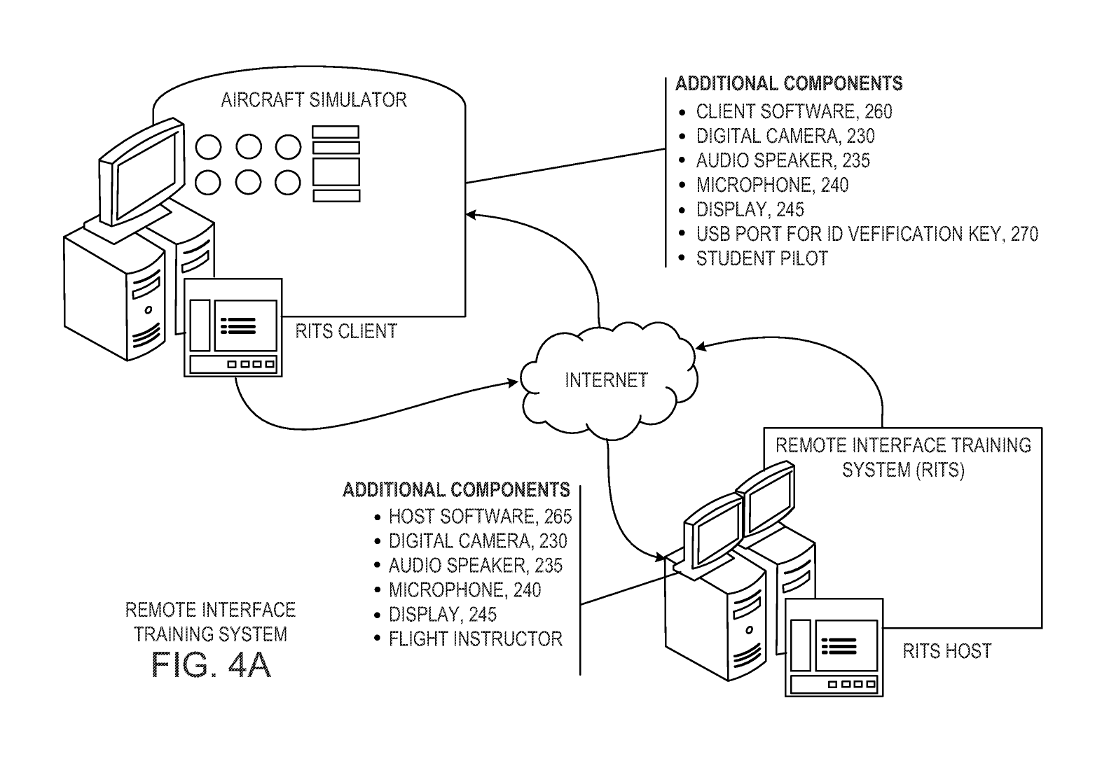

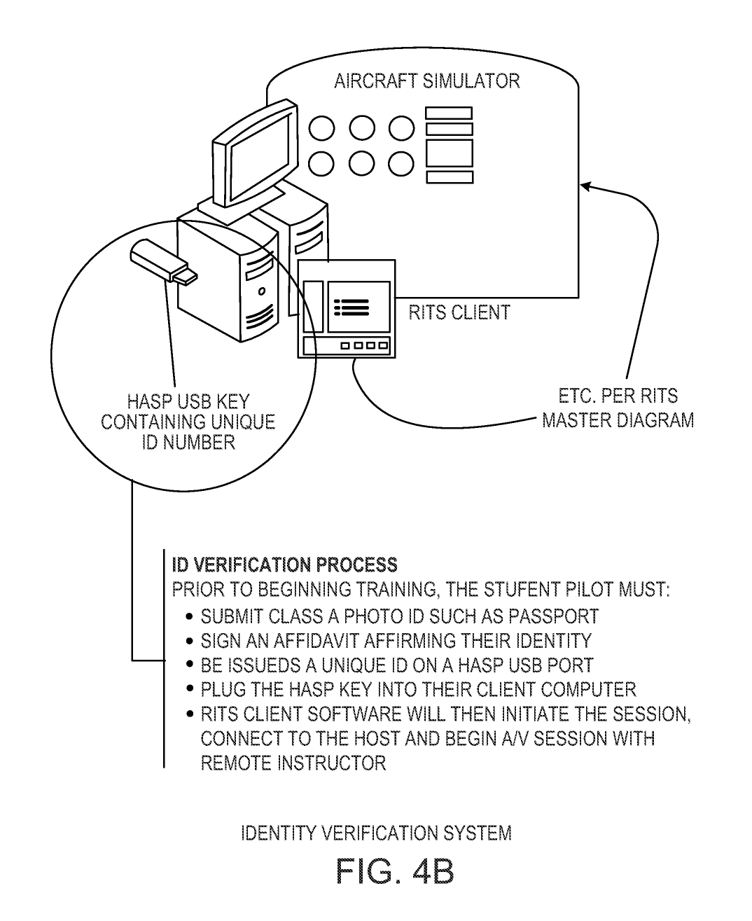

FIG. 4A is a diagram of the Remote Interface Training System (or, RITS) that may be used in conjunction with the aircraft simulator 250 described here. Using this integrated system, the Flight Instructor may conduct instruction with the Student Pilot from a remote location (e.g., from a different room, different building, different city, different country, or from any location where an appropriate data connection can be established and maintained), allowing for the productive use of the aircraft simulator 250 even during situations where it may not be practical or possible for the Flight Instructor and the Student Pilot to meet at a common location. Several specific requirements must be met in order for this type of remote training to be conducted in an effective and productive manner:

1. The Flight Instructor and Student Pilot must be able to clearly communicate orally;

2. The Flight Instructor must be able to continually monitor the Student Pilot's physical manipulation of the controls, switches, levers and accessories within the aircraft simulator 250;

3. The Flight Instructor must be able to continuously monitor and record the switch positions, lever positions and instrument displays of the aircraft simulator 250;

4. The Flight instructor must be able to continuously monitor and record the simulated geographic position, ground track, speed, altitude and attitude of the simulated aircraft as it is being flown by the Student Pilot and must be able to pause or freeze the simulated aircraft at any point in time during the instruction. In addition, the Flight Instructor must be able to reposition the simulated aircraft to any simulated geographic position including to any airport and runway of desired use, and modify the speed, altitude and heading of the simulated aircraft at any point in time;

5. The Flight Instructor must be able to manipulate (e.g., control) certain parameters and systems of the aircraft simulator 250 and certain parameters and systems of the simulated environment in which the aircraft simulator 250 is operating, such that the Student Pilot may notice and/or respond to the changes in the states of those parameters and systems. These include, for example, intentional or randomly generated system failures (instruments, electrical, mechanical, propulsion, fuel, etc) and/or irregularities, and/or changes in the simulated environment (weather, barometric pressure, time of day, season, etc.), and other elements of the simulated external environment surrounding the simulated aircraft (airport lighting, navigation signals, air traffic, etc.). Any or all of these parameters may be manipulated through the use of a scripted file whereby the Flight Instructor prepares a pre-defined training scenario prior to the commencement of the training session, or may be manipulated by the Flight Instructor in real time during the training session;

6. The Flight Instructor must be able to create and retain a record of all data recorded during the training session between the Flight Instructor and Student Pilot including Flight Instructor name, Student Pilot name, date, time, and the simulated geographic position, ground track, speed, altitude and attitude of the simulated aircraft. This record may be analyzed, evaluated and/or replayed for review by the Flight Instructor and/or Student Pilot and/or by any other authorized persons, agents, supervisors, underwriters, etc. including but not limited to the Federal Aviation Administration (FAA) and Transportation Security Administration (TSA).

The RITS system described here accomplishes the above criteria required for effective and productive remote instruction through the use of a system of audio components 235, 240, video components 230, 245, computers and integrated software 260, 265, together allowing for the required transfer of data in real-time, via a packet-switched network such as the internet (or other Local Area Network (LAN) or Wide Area Network (WAN)). The aircraft simulator 250 and instructor console 255 each contains these audio 235,240, video 230,245, computer and integrated software components 260,265. The aircraft simulator 250 and the instructor console 255 are each assigned a unique Internet Protocol (IP) address, allowing for secure and reliable transmission between the two separately located consoles via a common connection to the internet. Each component is further described as follows:

Audio: The RITS system uses audio microphones and audio speakers located within both the aircraft simulator 250 and the instructor console 255 to capture and output audio signals. These audio signals are continuously captured at one console 250 or 255 and transmitted to the other console 250 or 255 in real time. Once captured at one location, the audio signal is processed by the computer and software components 260, 265 and transferred via the internet to the other location, where it is processed by the computer and software 260, 265 and outputted on the speaker 235 at that location. This audio transfer is continuous and works equally in both directions; from the aircraft simulator 250 to the instructor console 255 and vice-versa, permitting uninterrupted two-way oral communication between the Flight Instructor and the Student Pilot.

Video components: The RITS system uses multiple digital video camera devices 230 to maintain multiple perspective views of the aircraft simulator environment, and of Student Pilot seated in the aircraft simulator 250 as well as of the Flight Instructor located in the instructor console 255. Analogous to the audio signals in the audio system 235,240 described above, the digital images are captured by the cameras 230, processed by the computers and software 260, 265 and transferred back and forth between the two locations via the internet in real time. This allows for continuous digital image transfer between the two locations, giving the Flight Instructor the ability to monitor the Student Pilot's physical presence, physical movements and physical manipulations of the controls within the aircraft simulator 250. In addition, the Student Pilot may view a digital image of the Flight Instructor, allowing the Flight Instructor to use physical gestures, diagrams and the like to better communicate with the Student Pilot.

Computer components: The computers are used as a common hub for the attachment of the audio 235, 240 and video components 230,245 and to process the data that is captured by these components as well as the data available from the aircraft simulator 250, which include speed, altitude, attitude, position, environment, failure states, switch positions, lever positions, flight control positions and instrument displays of the aircraft simulator 250.

Software component: The software component 260, 265 of the RITS system is used to compile input and output of data, establish a secure connection, monitor the connection state and transfer the data back and forth between the aircraft simulator 250 and the instructor console 255. This software 260, 265 is installed at each console and is referred to within FIGS. 4A and 4B as the Client Software 260 (installed on computer component of aircraft simulator 250) and Host Software 265 (installed on computer component of instructor console 255).

### Student Identity Verification

FIG. 4B is a diagram of the Identity Verification System (IVS) used in the present invention. This IVS permits the Flight Instructor to accurately verify the Student Pilot's identity prior to commencing training and at any time during the training through the use of a combination of digital camera image 230, 245 and a uniquely coded Universal Serial Bus (USB) key 270. The IVS is comprised of a multi-step process that includes the following elements:

1. A Student Pilot seeking to utilize the aircraft simulator for the purpose of receiving flight training from an authorized Flight Instructor must first submit proof of identity to the Flight Instructor (and/or system manager, system controlling agency, etc.) in the form of an acceptable Class A photo identity card and/or passport. In addition, the Student pilot must sign an affidavit affirming his/her identity;

2. Upon review of the above documentation, the Flight Instructor (and/or system manager, system controlling agency, etc.) may issue a Hardware Against Software Piracy (HASP) Universal Serial Bus Key (USB) key 270 containing a unique, embedded and un-modifiable identity code that will be associated only with this individual Student Pilot;

3. At the commencement of each training session between the Flight Instructor and the Student Pilot, the issued HASP USB key 270 must be in the possession of the Student Pilot and inserted into the USB port located within the aircraft simulator 250;

4. The insertion of the USB HASP key 270 will initiate the communication of data between the aircraft simulator 250 and the instructor console 255 allowing the Flight Instructor to confirm the Student Pilot's identity code from the HASP key 270 and further verify the identity visually, through the use of the video components of the RITS system 230, 245.

In compliance with Federal Aviation Administration (FAA) 14 CFR part 61 regulations, Flight Instructors must positively verify the identity of the Student Pilot who seeks to receive pilot training prior to and during conducting the training sought. In addition to these FAA regulations, the Department of Homeland Security Transportation Security Administration (TSA) 49 CFR part 1552 regulations also require the same identity verification; which must include verification of U.S. citizenship or approved foreign student status, for reasons of protecting national security. The advantage of the IVS is that simulator based pilot training may be conducted from a remote location while remaining in full compliance with these regulations established by the FAA and TSA.

With regard to the use of a USB HASP key 270, alternative (or additional) methods may be utilized to electronically and securely link the Student Pilot in the aircraft simulator 250, with the Student's verified identity data file available for review by the Flight Instructor at the Instructor Console 255. These alternative methods may include hardware and/or software systems varying from those as commonly used as a secure pin entry keypad (e.g., such as found at automated banking machines), or unique username and password (e.g., such as is commonly used to access online bank accounts), or Smartcard technology, or electronic thumbprint scanner. Indeed, other embodiments of the IVS system, may utilize one or more of these alternative methods while still achieving a same fundamental goal of the IVS system as a whole: to securely and accurately verify that the Student Pilot operating the aircraft simulator 250 has been approved to do so by, and is positively identified to the Flight Instructor providing instruction from the Instructor Console 255 through the use of the RITS system.

### Exemplary Computer System Environment

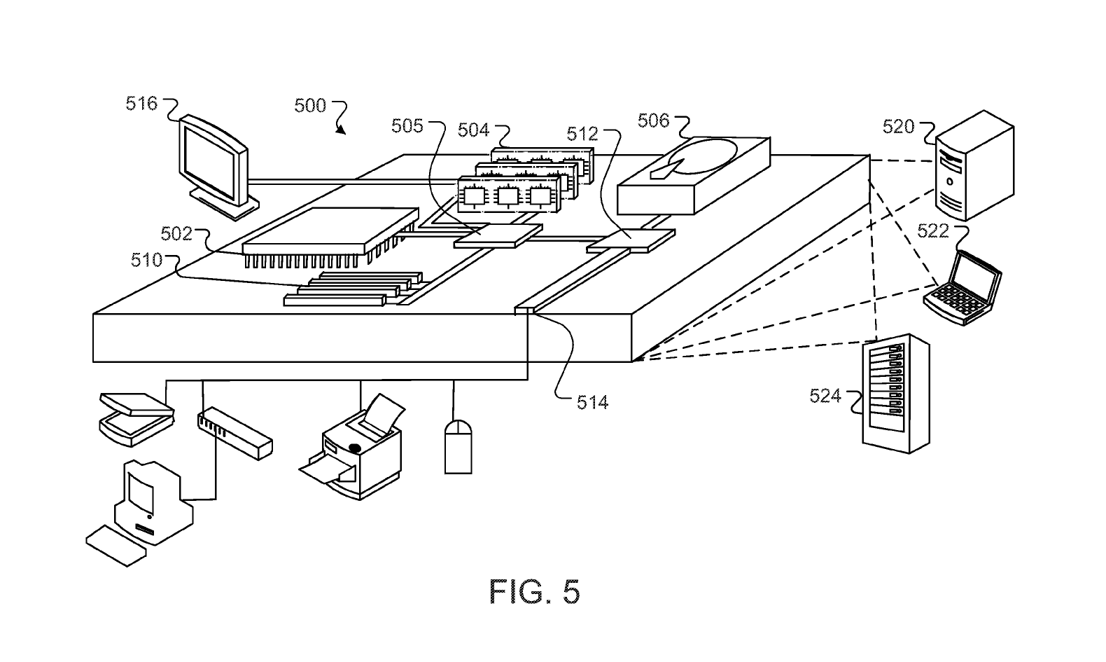

FIG. 5 is a block diagram of computing devices 500, 550 that may be used to implement certain systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Additionally computing device 500 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. An aircraft simulator comprising:
a plurality of rigid support members interconnected to form a load-bearing exoskeleton;
one or more flexible, resilient planar panels that are disposed in an interior of and affixed to the load-bearing exoskeleton such that the one or more planar panels are flexed to form a contour that approximates a hull of an aircraft; and
a plurality of input and output mechanisms that collectively provide flight simulation functionality.

2. The aircraft simulator of claim 1 wherein the rigid support members comprise straight aluminum channels.

3. The aircraft simulator of claim 1 wherein the rigid support members are releasably interconnected to facilitate easy assembly and disassembly of the load-bearing exoskeleton.

4. The aircraft simulator of claim 1 wherein the one or more flexible, resilient planar panels comprise PVC plastic.

5. The aircraft simulator of claim 1 wherein the one or more flexible, resilient planar panels are removably affixed to the load-bearing skeleton such that the one or more flexible, resilient planar panels resume a planar state upon being removed from the load-bearing skeleton.

6. The aircraft simulator of claim 5 further comprising bolts and T-lock nuts to removably affix the one or more flexible, resilient planar panels to the load-bearing exoskeleton.

7. The aircraft simulator of claim 1 further comprising one or more pivot connectors that form adjustable angles between adjacent rigid support members.

8. The aircraft simulator of claim 1 further comprising a student console having:
a digital camera;
an audio speaker;
a microphone;
a display;
a computer system; and
a network connection.

9. The aircraft simulator of claim 8 further comprising an instructor console, remote from the student station, configured to enable an instructor to monitor, control, and communicate with student console from a remote location via a wide area network.

10. A method of constructing an aircraft simulator, the method comprising:
interconnecting a plurality of rigid support members to form a load-bearing exoskeleton;
disposing one or more flexible, resilient planar panels in an interior of the load-bearing exoskeleton; and
affixing the one or more flexible, resilient planar panels to the load-bearing exoskeleton such that the one or more planar panels are flexed to form a contour that approximates a hull of an aircraft.

11. A modular method of constructing an aircraft simulator that can be rapidly assembled, rapidly disassembled and easily dimensionally modified in overall shape and form, together which greatly reduce manufacturing, and transport costs typically associated with the construction of aircraft simulators.

12. A method performed by data processing apparatus, the method comprising:
capturing sounds and images corresponding to activity an operator located in a cockpit of an aircraft simulator;
digitizing the captured sounds and images;
transmitting over a packet-switched network in real time (a) the digitized sounds and images, and (b) outbound information relating to respective current states of a plurality of flight simulation parameters, to a remotely located instructor console;
receiving over the packet-switched network in real time from the remotely-located instructor console (c) digitized sounds and images corresponding to activity of an instructor located at the remotely located instructor console, and (b) inbound information relating to a change of at least one flight simulation parameter; and
changing flight simulation functionality of the aircraft simulator based on the received inbound information relating to the change of the at least one flight simulation parameter.

13. The method of claim 12 further comprising:
providing a receptacle within the aircraft simulator cockpit configured to receive an electronic key that is encoded with information corresponding to a unique identity; and
reading the unique identity of the electronic key inserted into the receptacle; and
transmitting the unique identity to the remotely located instructor console, thereby facilitating identification of the operator by the instructor.

14. A aircraft simulator training system that permits reliable, secure and clear communication between a Flight Instructor and a Student Pilot who are not co-located, while accurately maintaining positive identity verification throughout this process.

15. An aircraft simulator comprising:
a simulated aircraft cockpit formed from a rigid, load-bearing exoskeleton and a plurality of flexible, resilient panels releasably attached to an interior of the rigid, load-bearing exoskeleton;
a computer system configured to support flight simulation functionality;
a plurality of input controls and output devices operably coupled to the computer system;
a remote interface configured to enable a remotely-located instructor to communicate with an operator of the aircraft simulator and further configured to enable the remotely-located instructor to monitor and control one or more parameters of the flight simulation functionality; and
a student identity verification system configured to enable the remotely-located instructor to verify an identity of the operator of the aircraft simulator.
